(19) United States
(12) Patent Application Publication
(10) Pub. No.: US 2026/0299903 A1
(43) Pub. Date: Oct. 1, 2026

(54) MULTI-AGENT BASED ASPECT MANAGEMENT IN AN APPLICATION DEVELOPMENT ENVIRONMENT

(71) Applicant: Trixta Pte. Ltd., Singapore (SG)

(72) Inventors: Barry Worthington Hill, Cape Town (ZA); Mark Levitt, Cape Town (ZA)

(73) Assignee: Trixta Pte. Ltd., Singapore (SG)

(21) Appl. No.: 19/577,103

(22) Filed: Mar. 24, 2026

Related U.S. Application Data
(60) Provisional application No. 63/779,404, filed on Mar. 28, 2025.

(51) Int. Cl. G06F 8/35

(52) U.S. Cl. CPC G06F 8/35

(57) ABSTRACT

A method and system for multi-agent based aspect management in an application development environment are provided. The method may be conducted in the development environment comprising functional element templates. The method may include initiating an aspect instance container for a cross-cutting concern including two or more aspect instance modules arranged to define a lifecycle of the concern, and provide an agent module for the aspect instance container. The method may call, in a first stage of the lifecycle by a first aspect instance module, the agent module to obtain data elements relevant to the concern and storing the data elements in a data structure. The method may execute, in a further stage of the lifecycle by a further aspect instance module, an operation based on the data elements stored in the data structure, including creating and configuring a functional element instance from the templates.

### CROSS-REFERENCE TO RELATED APPLICATIONS

This application claims priority from U.S. provisional patent application No. 63/779,404 filed on 28 Mar. 2025, which is incorporated by reference herein.

### FIELD

This disclosure relates generally to arrangements for software development and/or software engineering, including an application development environment for software design and/or the creation or generation of source code and/or executable code. More particularly, the disclosure relates to language model-based agent modules in an application development environment. The agent modules may be based on large language models (LLMs), such as generative pretrained transformers (GPTs) and the like.

### BACKGROUND

Automation is an ever-increasing feature offered in the field of software development. Applications such as Copilot™ offer developers a “developer-on-the-shoulder” assistant, purporting to speed up development. Automation may be imbedded within a development environment, offering seamless, almost unnoticeable integration of automation tools. Conventional Retrieval-Augmented Generation (RAG) frameworks, while powerful, face several challenges that can limit their effectiveness, particularly as they attempt to handle more complex or dynamic information contexts.

Traditional RAG models often struggle to maintain context over extended interactions or complex queries. They usually rely on recent or most relevant information to answer questions put to the RAG model. However, without structured memory or multi-level context management, they can lose track of continuity. This may result in responses that are accurate in isolation but lack coherence when viewed as part of a longer conversation or sequence of interactions. Complex conversations or tasks that require reference to multiple, intertwined details across contexts can become difficult to manage, especially in environments with multi-faceted data.

Conventional RAG systems may suffer from limited memory capabilities as they typically do not have sophisticated memory layers, restricting them to short-term or single-query context. While RAG can retrieve relevant documents or snippets from a source, it lacks a mechanism for medium- or long-term memory retention, meaning it can't “learn” or build upon previous interactions. In applications where consistent historical information (e.g., customer preferences, past decisions, or recurring themes) is essential, this limited memory can hinder personalized and contextually rich responses.

Traditional RAG models rely heavily on retrieving data from a single or limited set of sources, which are often siloed and static. This structure can be limiting when there is a need for dynamic or cross-domain knowledge, where information from various domains needs to be connected for a holistic response. RAG systems generally don't integrate cross-cutting or interdisciplinary insights seamlessly, which reduces their adaptability and responsiveness in complex, multi-dimensional queries. Thus, while RAG frameworks attempt to store facts and aim to optimize fact retrieval, retaining facts and keeping them up to date in real-time may become difficult.

In a similar vein to the limited scope of data from limited sets of sources, many RAG systems depend on periodically updated or manually curated data sources, making it difficult to keep up with fast-changing information or adapt to new data as it emerges. This may lead to outdated responses, especially in environments with real-time information needs or domains with constantly evolving data. The challenge here is implementing a mechanism for continuous “learning” or real-time updating, which conventional RAG systems generally lack.

Larger systems that are being developed may comprise a large volume of data. As the amount of data increases, RAG systems may struggle with scaling retrieval efficiently while keeping latency low. Performing similarity searches over very large databases can become computationally expensive, and optimizing these processes for both speed and accuracy can be challenging. This is particularly true for systems that need to serve a high volume of real-time queries without sacrificing performance or accuracy.

In summary, conventional RAG faces constraints related to limited memory, contextual continuity, static knowledge bases, scalability, and the inability to handle interdisciplinary knowledge seamlessly. Addressing these challenges often requires a more advanced memory and communication architecture, as well as the ability to integrate and update knowledge dynamically, to truly support complex and evolving information needs.

The above limitations, including managing multiple levels of automation, may result in a collapse of the ability for each, independent, automated task to achieve its own outcome. Conflicting requirements, siloed knowledge bases, and limited resources distributed over large systems (which may be being worked on concurrently), may lead to unsatisfactory results over a longer period of time, requiring significant debugging time with human intervention.

There is accordingly thought to be scope for improvement.

The preceding discussion of the background is intended only to facilitate an understanding of the present disclosure. It should be appreciated that the discussion is not an acknowledgment or admission that any of the material referred to was part of the common general knowledge in the art as at the priority date of the application.

### SUMMARY

In accordance with an aspect of the disclosure there is provided a computer-implemented method comprising:
initiating an aspect instance container for a cross-cutting concern, the aspect instance container including two or more aspect instance modules arranged to define a lifecycle of the cross-cutting concern, the aspect instance container having access to an aspect instance data structure created for the aspect instance container;
providing an agent module for the aspect instance container, the agent module having access to a large language model (LLM) and being configured to obtain data elements relevant to the cross-cutting concern for storage in the aspect instance data structure;
in a first stage of the lifecycle, calling, by a first aspect instance module, the agent module to obtain data elements relevant to the cross-cutting concern and storing the data elements in the aspect instance data structure; and,
in a further stage of the lifecycle, executing, by a further aspect instance module, an operation based on the data elements stored in the aspect instance data structure, wherein executing the operation includes creating a functional element instance from a library of functional element templates and configuring the functional element instance based on the data elements, wherein the functional element instance represents a block of code forming part of a body of code for compiling into an executable.

Each aspect instance module of the two or more aspect instance modules may be implemented using a functional element instance. The functional element instance may be in the form of a schema validation-based file including configuration that governs operation of the aspect instance module.

Each aspect instance module of the two or more aspect instance modules may include a token store for storing tokens allocated by a token allocation component. The tokens may be required for calling the agent module. The method may include controlling resource utilization by controlling allocation of tokens to each aspect instance module of the two or more aspect instance modules. The agent module may determine a required number of tokens and a required type of token to process instructions and execute further tasks.

Initiating the aspect instance container may include linking the aspect instance container to a functional element instance in the form of a space. The method may include initiating an aspect instance module for each of one or more of: definition; planning; operating; and monitoring stages of the lifecycle. The agent module may have read and/or write access to the aspect instance data structure. The aspect instance data structure may store data elements for each of one or more of: aspect objectives; aspect learned data; aspect plans; aspect operations; and, aspect monitoring. The aspect instance data structure may provide a view into one or more of a current understanding, lifecycle phase, strategy, operational overview and feedback for the cross-cutting concern. The aspect instance data structure may include fields for storing data elements represented in natural language.

The application development environment may include a further functional element instance created from the library of functional element templates. The further functional element instance may include an aspect hooking module for connecting the further functional element instance to the aspect instance container. The aspect hooking module may connect the further functional element instance to an aspect instance module of the two or more aspect instance modules. The aspect hooking module may provide runtime instructions which cause, during runtime of the executable, inputting of data elements into the aspect instance container. The data elements may be usable by the agent module to: refine; provide more context; be evaluated, processed or executed; or, to provide feedback.

The further functional element instance may include a step macro including an action execution component. The method may include configuring the further functional element instance to reference the aspect instance container. The method may include configuring the action execution component to reference the aspect instance container.

The further functional element instance configured may be in the form of a step. Configuring the further functional element instance to reference the aspect instance container may be based on configuration of an even further functional element instance in the form of a space of which the step is a dependent. Executing the operation may include calling the agent module to execute the operation. The aspect instance container may be represented by one or more blocks of code forming part of the body of code. The method may include compiling the body of code into the executable.

In accordance with an aspect of the disclosure there is provided a system comprising: a non-transitory computer-readable storage medium; and one or more processors coupled to the non-transitory computer-readable storage medium, wherein the non-transitory computer-readable storage medium comprises program instructions that, when executed on the one or more processors, cause the system to perform operations comprising:
initiating an aspect instance container for a cross-cutting concern, the aspect instance container including two or more aspect instance modules arranged to define a lifecycle of the cross-cutting concern, the aspect instance container having access to an aspect instance data structure created for the aspect instance container;
providing an agent module for the aspect instance container, the agent module having access to a large language model (LLM) and being configured to obtain data elements relevant to the cross-cutting concern for storage in the aspect instance data structure;
in a first stage of the lifecycle, calling, by a first aspect instance module, the agent module to obtain data elements relevant to the cross-cutting concern and storing the data elements in the aspect instance data structure; and,
in a further stage of the lifecycle, executing, by a further aspect instance module, an operation based on the data elements stored in the aspect instance data structure, wherein executing the operation includes creating a functional element instance from a library of functional element templates and configuring the functional element instance based on the data elements, wherein the functional element instance represents a block of code forming part of a body of code for compiling into an executable.

In accordance with an aspect of the disclosure there is provided a system including a memory for storing computer-readable program code and a processor for executing the computer-readable program code, the system comprising:
an aspect instance initiating component for initiating an aspect instance container for a cross-cutting concern, the aspect instance container including two or more aspect instance modules arranged to define a lifecycle of the cross-cutting concern, the aspect instance container having access to an aspect instance data structure created for the aspect instance container;
an agent providing component for providing an agent module for the aspect instance container, the agent module having access to a large language model (LLM) and being configured to obtain data elements relevant to the cross-cutting concern for storage in the aspect instance data structure;
an agent calling component for, in a first stage of the lifecycle, calling, by a first aspect instance module, the agent module to obtain data elements relevant to the cross-cutting concern and storing the data elements in the aspect instance data structure; and,
an operation executing component for, in a further stage of the lifecycle, executing, by a further aspect instance module, an operation based on the data elements stored in the aspect instance data structure, wherein executing the operation includes creating a functional element instance from a library of functional element templates and configuring the functional element instance based on the data elements, wherein the functional element instance represents a block of code forming part of a body of code for compiling into an executable.

In accordance with an aspect of the disclosure there is provided a computer program product, the computer program product comprising a computer-readable medium having stored computer-readable program code for performing the steps of:
initiating an aspect instance container for a cross-cutting concern, the aspect instance container including two or more aspect instance modules arranged to define a lifecycle of the cross-cutting concern, the aspect instance container having access to an aspect instance data structure created for the aspect instance container;
providing an agent module for the aspect instance container, the agent module having access to a large language model (LLM) and being configured to obtain data elements relevant to the cross-cutting concern for storage in the aspect instance data structure;
in a first stage of the lifecycle, calling, by a first aspect instance module, the agent module to obtain data elements relevant to the cross-cutting concern and storing the data elements in the aspect instance data structure; and,
in a further stage of the lifecycle, executing, by a further aspect instance module, an operation based on the data elements stored in the aspect instance data structure, wherein executing the operation includes creating a functional element instance from a library of functional element templates and configuring the functional element instance based on the data elements, wherein the functional element instance represents a block of code forming part of a body of code for compiling into an executable.

Further features provide for the computer-readable medium to be a non-transitory computer-readable medium and for the computer-readable program code to be executable by a processing circuit.

Embodiments of the technology will now be described, by way of example only, with reference to the accompanying drawings.

### BRIEF DESCRIPTION OF THE DRAWINGS

In the drawings:

FIG. 1 is a schematic diagram which illustrates an example application development environment in accordance with the present disclosure;

FIG. 2A is a schematic diagram which illustrates example networks of functional element instances and associated agent modules;

FIG. 2B is a schematic diagram which illustrates an example treelike construct of functional element instances;

FIG. 3 is a schematic diagram which illustrates an example aspect instance container in accordance with the present disclosure;

FIG. 4 is a schematic diagram which illustrates an example computing system on which the application development environment of FIG. 1 may be hosted;

FIG. 5A is a swim-lane flow diagram which illustrates an example method executed within an application development environment in accordance with the present disclosure;

FIG. 5B is a swim-lane flow diagram of an example method for obtaining data elements relevant to a cross-cutting concern;

FIG. 6 is a block diagram of example system components in accordance with the present disclosure; and,

FIG. 7 illustrates an example of a computing device in which various features of the disclosure may be implemented.

### DETAILED DESCRIPTION WITH REFERENCE TO THE DRAWINGS

A method and system for multi-agent based aspect management in an application development environment are provided. With a growing use of automation, organizations that utilize a plurality of automation agents may encounter problems with numerous agents operating without constraints. The automation agents may be running concurrently on a single system, such as the application development environment, performing a variety of changes depending on the configuration of the automated agents. In some examples, the automation agents may not only be operating on a single system, but across distributed services of an organization.

However, many concurrently running automation agents add difficulty to a variety of factors, such as: balancing overall computational spend and strategic effort, dealing with conflicting requirements, handling failure to comply with organizational policies (or even detecting that some policies are not being complied with), or determining that the automation agents are changing a system in the correct order.

For example, one or more automation agents may be provided for a marketing department. The automation agent may be configured to complete a task or action according to specific rules and/or constraints, while being provided pre-defined permissions for completing the task or action. In some examples, the automation agent may be provided an objective/goal instead of or in addition to a task or action. The automation agent may operate beyond what a non-automated agent would, which may include tasks or actions such as creating campaigns. Performing the tasks or actions may consume large amounts of resources and energy. Simultaneously, a product development department may be developing a product, but the product does not yet exist. The automation agent of the marketing department may be pulling resources away (i.e. consuming a large portion of the total available resources) from the product development department, potentially hindering product development. In this case, the marketing department agent may be paused or resources may be reassigned away from them and directed towards the product development department, which may require human intervention.

In a world of extreme agent-based automation, simply setting and controlling how much power or resources each automation agent receives relative to other agents may not be sufficient as a solution for complex scenarios.

Within the present disclosure, the multi-agent based aspect management may allow for effective operations and decision making in real-time. The aspect management may move from receive data, determine facts from the data, and in a sense ‘understand’ the facts for effective operations and decision making. The aspect management may be provided as part of a larger operating system that functions as a harness for all agents in a system. For example, a plurality of agents may be operating within an organization. The larger operating system may control or harness agents operating within the organization to perform various tasks, such as obtaining information relating to various operational processes of the organization, interact with team members, and the like.

In some examples, the use of automation agents or agent modules may include automation of aspects of an executable software. Within the field of software development, an aspect may be a feature linked to a part of a software program. In some examples, the aspect may be a concern. A concern may be a set of information that has an effect on the software of a computer software program. In some examples, the concern may be a cross-cutting concern, which may be an aspect of a program that affects several modules or divided parts of a software program, without the possibility to encapsulate the aspect within a single function or module of the software program (i.e. the aspect cross-cuts multiple parts of the system, adding complexity to the system as it can no longer be easily divided). Example cross-cutting concerns include logging, compliance, or geographical features as they may interact with (or “concern”) several modules and/or functions.

In the present disclosure, cross-cutting concerns may additionally include information related to an organization, and in particular, information important to the functioning of an organization. For example, an organization's objectives (building out a product versus marketing an already developed product) would be an aspect that is also a cross-cutting concern, as the objectives may include information that will have an effect across the entire breadth of an organization.

Within the context of the present disclosure, an aspect instance container may be configured for a concern (which may be a cross-cutting concern) across a lifecycle of the aspect. Additionally, an aspect instance container may be configured to manage, control and/or delegate, to one or more agents, any one or more of the following for the purpose of implementing the cross-cutting concern: tasks, functions, roles, objectives, and goals. The aspect instance containers may be applied to steps, which may be viewed as building block functions to achieving the objectives and/or goals. The concept of steps, and where they fall within the automation agent and the aspect lifecycle will be elaborated on later. In practical implementations, there may be a plurality of concerns, and an aspect instance container may be provided and configured for each.

An aspect instance container may find and store (via an aspect instance data structure) up-to-date information relevant to a specific objective or cross-cutting concern, allowing for better separation of concerns and differentiation. The finding and keeping up-to-date information within the aspect instance container may better optimize the cross-cutting concern, specifically including how data is stored and retrieved (as compared to, e.g., a one-size-fits-all approach of RAG alone).

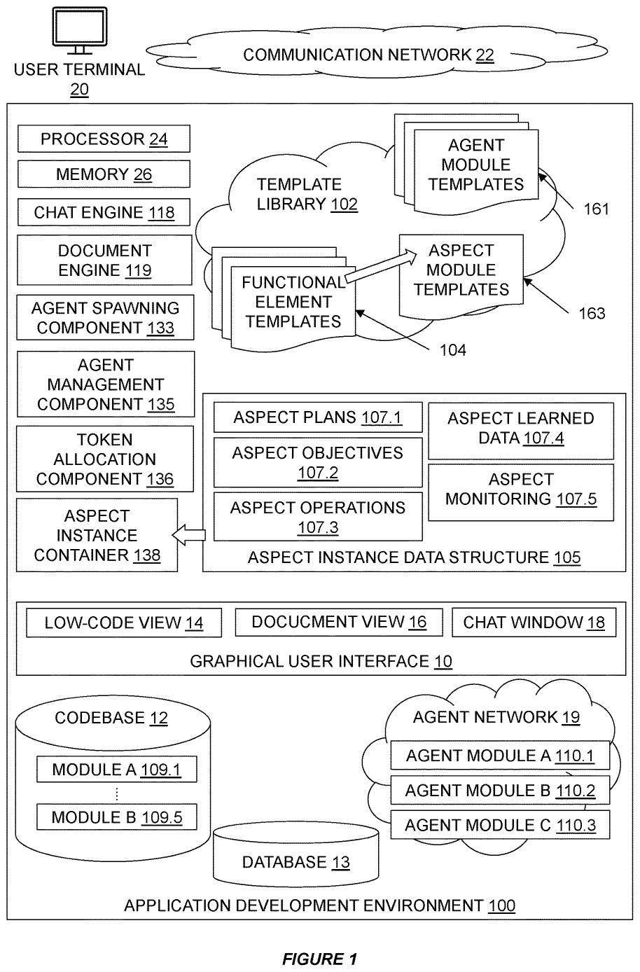

FIG. 1A is a schematic diagram which illustrates an example application development environment (100) in accordance with the present disclosure. The application development environment may include a body of code or “codebase” (12), which may be a collection of modules (109.1-109.2) of source code (“code modules”), which provides a particular software system, application, or software component (hereinafter “application software”). The application development environment may include or have access to a database (13) which may store information related any one of: an organization of the application development environment; and, an organization of a system of which the application development environment is associated with. The information related to an organization may include any or more of: documents, whitepapers, business models, project plans, and the like.

The application development environment may be provided by an application development platform which is accessible to a plurality of participants including human end-users via their respective user terminals (20) and optionally various machine learning-based agent participants (such as the one or more agent modules described herein). The use of human end-users and machine learning-based agent participants may form an agent based system that exhibits both probabilistic and deterministic behavior. The development platform may be accessible to the user terminals via a suitable communication network (22), such as the internet. In some examples, the application development environment may include an integrated development environment (IDE), which may be provided within the larger operating system.

The development platform may be provided by any suitable computing device or computing devices and may include or have access to one or more processors (24) for executing the functions of components described below, which may be provided by hardware or by software units executing on the development platform. The software units may be stored in a memory (26) and instructions may be provided to the one or more processors to carry out the functionality of the described components. In some cases, for example in a cloud computing implementation, software units arranged to manage and/or process data on behalf of the development platform may be provided remotely.

The application development environment includes a template library (102) of functional element templates (104) from each of which one or more functional element instances can be created. In some examples, the library (102) includes agent module templates (161) from which instances of agent modules can be created. There may for example be an agent module template for each type of functional element instance template. The library (102) may include aspect module templates (163). Each aspect module template (163) may be a type of functional element template (104) related to aspects.

The application development environment may provide a graphical user interface (10) via which an end-user can build the codebase (12) via either: a low-code view (14) or a document view (16). The document view may provide a document editor, such as a cloud-based “what you see is what you get” document editor which permits an end-user to edit and manipulate the look and content of a document directly. The application development environment may further provide a chat window (18) via which participants-including human end-users and/or various agent modules (110.1, 110.3) included in an agent network (19) provided by the application development environment-may chat with each other.

Creation of a functional element instance may entail one or more of: creation of a visual representation thereof in the low-code view (14); creation of an end-user (human) readable textual description thereof in a document view (16); creation in the codebase (12) of a code module (e.g., 109.1) corresponding to the functional element instance; and, initiation or spawning in the agent network (19) of an agent module (110.1) linked to the functional element instance.

The term “textual description” of the code module as used herein should be interpreted to include a plain language (or prose) description of the code module. In other words, the textual description may be in a form of written language that follows the natural flow of speech, a language's ordinary grammatical structures, or typical writing conventions, formatting and the like. The description may be a description of the functionality of the code module. For example, the description may state the purpose that the code module is designed or expected to fulfill. For example, the description may include details relating to the purpose, configuration, attributes, characteristics, dependencies of the code module, and the like.

The textual description of the code module should be distinguished from the code module itself, and from the functional element instance associated therewith. The code module may be actual code (e.g. source code) compliant with relevant syntactical constraints of the programming language in which it is written (such as Python, C++, Rust, or the like). Likewise, the functional element instance may be in the form of a schema validation-based file representing structured data (such as JSON, XML, BPML or the like).

The library of functional element templates may be dynamic with new functional element templates being added and retired functional element templates being removed over time. The functional element templates may be grouped into different types of functional element templates (e.g. including “spaces”, “steps”, “roles”, “interactions” “flows”, “agents”, and “aspects”).

It follows that a functional element instance created from a functional element template will be of the same type as that of the template from which it is created. Although the illustrated example shows only a first group (104) of functional element template types, a practical implementation may have a plurality of such groups. Each group of functional element type may include one or more functional element templates (e.g. there may be a plurality of functional element templates within a functional element type). There may for example be functional element templates for each of “spaces”, “steps”, “roles”, “interactions” “flows”, “agents” and “aspects”.

In an example application development environment, spaces may provide a container mechanism that allows one to create servers, services and/or microservices. Spaces may represent a functional unit of an organization or a collection of system-specific components. Each space is the boundary of the infrastructure where all other components are housed. Interactions (actions or reactions) connect or point to process flows. Actions are grouped by roles and are used to trigger process flows. Interactions could be considered analogous to API endpoints. Participants (including end-users and/or agent modules), other spaces, or external systems may connect to roles as agents. Many agents can connect to the same role and agents can be connected to multiple roles. Roles may limit rights to specific agents that take on that role. A role is what an agent authenticates against. Roles are used to manage authentication and permissions. Flows are process flows which contain steps. A flow may be a workflow which is triggered by an action and contains the logic of how steps are connected. Steps are the building blocks of flows and may be termed building block functions. A step may define a block or snippet of functional code that is run when that part of a flow is reached. A step may take inputs from previous steps in a flow and will often result in an output being returned.

An aspect instance container (138) for a cross-cutting concern may be initiated or created within the application development environment. Each aspect instance container (138) may include one or more aspect instance modules. Each aspect instance module may perform a specific role or function within the container (138). An aspect instance module may be a special type of functional element instance.

The container (138) may include or have access to an aspect instance data structure (105), in which data elements related to the container and/or cross-cutting concern may be stored. The aspect instance data structure (105) may include one or more fields. The one or more fields may for example store data elements for each of one or more of: aspect objectives (107.2), aspect learned data (107.4), aspect plans (107.1), aspect operations (107.3), and aspect monitoring (107.5). The aspect instance data structure (105) may provide a view into the current understanding, lifecycle phase, strategy, operational overview and feedback for the aspect (which may be a cross-cutting concern). The fields may store data elements represented in natural language. The stored data elements may be usable by the agent module to: refine; provide more context; be evaluated, processed or executed; or, to provide feedback.

The aspect plans (107.1) may include any one or more of: an overall plan of the aspect, requirements of the aspect, and an outcome for the aspect. The plans (107.1) may provide a view into the current understanding, lifecycle phase, strategy, operational overview, and/or feedback to the aspect instance container (138).

The aspect learned data (107.4) may include data associated with a particular aspect instance container. The data may be obtained by agent modules. The aspect objectives (107.2) may include a list of objectives that are to be achieved by the aspect instance container (138).

The aspect operations (107.3) may store a set of operations that the aspect instance container is permitted (by the roles) to perform with a space. The aspect operations (107.3) may store a list of already complete operations performed, including associated data for reviewing previous operations.

The aspect monitoring (107.5) may provide monitoring features to the aspect instance container (138). The aspect monitoring (107.5) may monitor operations performed by the aspects operations (107.3) to analyze and provide feedback to the agent module associated with the aspect instance container (138).

For example, an aspect instance container (138) may be created to examine a piece of software code (whereby examining a piece of software may also be the objective of the aspect and stored in the aspects objectives (107.2)). The aspect plans (107.1) may include a list of pre-defined steps for the aspect instance container to perform. The aspects learned data (107.4) may include data necessary to complete the steps, such as the software code, and in some examples, software code from other completed aspect instance containers. The aspect operations (107.3) may include a set of operations, such as character deletions or insertions into the code. In some examples, the aspect operations (107.3) may include coordinating agent modules and external systems in accordance with requirements of the cross-cutting concern. Coordinating agent modules and external systems may be achieved through building up, editing and/or applying existing software. The aspect monitoring (107.5) may include criteria that the software code output must meet, such as unit tests and software syntax that may be required, and to report the monitoring analysis to the aspect operations to perform more actions if necessary.

The term “aspects instance container” as used herein may refer to a logical grouping of aspect instance modules and an associated aspect instance data structure. In one example, the logical grouping may be achieved by way of a unique aspect identifier created for a particular cross-cutting concern and assigned to aspect instance modules and an aspect instance data structure created for the particular cross-cutting concern. In another example, an aspect instance container may be implemented as a functional element instance created from a corresponding functional element template, with the aspect instance modules related thereto being implemented as functional element instances created from functional element templates and being dependent upon or nested within the aspect instance container.

A functional element template may be provided by a schema-based validation file, which may for example be in the form of a small discrete file that has scaffolding (definitions) or shells defined in a text-based data interchange format for representing structured data based on syntax. The schema validation-based file may include a configuration that governs operation of an aspect instance module of the aspect instance container. The scaffolding tells the compiler how to operate, the version information, etc. For example, the scaffolding may be provided as JavaScript™ Object Notation (JSON™). JSON is a standard text-based format for representing structured data based on JavaScript object syntax commonly used for transmitting data in web applications. In another example, the scaffolding may be provided in Extensible Markup Language (XML), Business Process Modelling Language (BPML—an XML-based language for business process modelling), YAML (a human-readable data-serialization language) or the like.

The functional element templates may provide visual building tools associated with each of spaces, roles, agents, interactions, flows, steps, and aspects. A functional element instance created from a functional element template may be configured for configuration and interconnection via the low-code view. Visual representations of configured functional element instances may be based on or provided by the visual building tools. A configured functional element instance may be in the form of a schema validation-based file including configuration parameters, details, data points or the like that govern the particular operation of that instance of the functional element template. The visual building tools may be manipulated by one or more of the plurality of participants via the user interface for configuration and interconnection of representations of building-block functions in order to generate application software.

The low-code view may include functionality for connecting an action and/or reaction to a flow graph and in turn assigning one or more roles and/or agents to a flow graph. Each flow graph may be built up with a number of steps, each of which is based on a step macro. In some examples, any type of functional element instance may include a step macro. For example, a functional element instance may be a step. The step may be configured to reference an aspect instance container based on a configuration of a functional element instance of a space of which the step is a dependent.

A step macro may be made up of one or more files, each of which includes one or more functions. In some examples, the step macro may include an action execution component. In some cases, a step macro may also refer to other files (that are not a part of the step macro) during compilation. Each step macro may be configured for configuration and interconnection via the low-code view to generate source code and/or executable code. Step macros may be configured and interconnected in the user interface to build a flow graph. The flow graph may be a visual flow that is drawn in the low-code view and displays how various steps in the flow reference each other. Each step in a flow may be an instance of a type of step macro that can be interconnected with other steps (being instances of the same or other types of step macros) and configured via the user interface. Each step may be associated with a block of executable code which may form a part of the codebase (e.g., being a particular computer program or application software that is being developed), which may include executable code of multiple steps in a flow. The flow graph may be a schematic representation of source code (e.g., in: Python, Rust, Elixir or the like) and/or executable code that is generated through configuration and interconnection of step macros.

Each flow graph may be a definition of the following components: visual instructions on how the low-code view should display them; the control flow with order of steps with each step defining what to call next (such as a branches field, an inner routing field and a settings field, etc.); and the code modules to execute before proceeding (such as the code modules to execute in combination with the configuration values before proceeding). The visual instructions and the control flow may be combined and leveraged to allow for the visual modelling and defining of the logic of the code around the modules that are actually executed. The development environment described herein may be configured to derive a visual representation of code, the flow graph, from the code itself.

The graphical user interface (10) may be displayed to the participants via their respective user terminals, which may be in the form of any suitable computing device. The low-code view of the graphical user interface may define a bounded context in the form of a space in which roles and actions, and ultimately the codebase, relating to a functional unit within an organization, for example, can be described. The bounded context may be represented graphically in the low-code view as a circle or other shape to which and in which actions or roles may be added and configured. The user interface may include functionality for managing actions and roles. The user interface may include functionality for managing actions against a role, setting permissions for a role, assigning agents to one or more roles and the like. Managing actions against roles may allow for control as to which agents (being users or systems) can call which actions (based on the role to which they are assigned).

The application development environment may include a chat engine (118) which provides a chat function for chat between the participants accessing the development environment. The chat engine may support multimodal chat by way of which participants can exchange any one or more of text, audio, images, videos and the like. The chat engine and chat window may support text, audio, video and/or virtual environment-based chat (such as through avatars in the metaverse). The chat engine allows participants to chat with one another while viewing the user interface displayed via their respective user terminals. The user interface may be in the form of a shared screen or may include a shared area or zone which is visible to all participants in the chat. In this manner, manipulation, for example, of a graphical element within the user interface by one participant may be simultaneously visible to the other participants. In some examples, chats are bound to a context of development, and as a participant moves through different contexts of development (e.g. by moving through different sections of a document view), the chat engine may call and output, via the chat window, different chat histories associated with the different contexts of development. The chat engine may also be configured to archive a chat history once it has been marked resolved and once any change being discussed therein has been made and promulgated through to the codebase.

The application development environment may include a document engine (119) which provides the document view (16) via the graphical user interface (10). The document engine may compile a document from textual descriptions of code modules generated in accordance with the present disclosure. In some examples, the document engine may compile a document from data elements related to the cross-cutting concern, and in particular, textual descriptions of the data elements. The document engine may be configured to interact with the agent modules of the agent network to update different sections of the document based on updated textual descriptions. Although the term “sections” in the context of the document implies different sections of the same document, in some examples each of the different sections is in the form of a discrete document and the collection of discrete documents together make up documentation describing the codebase and hence the application under development.

The development environment may include an agent spawning component (133) and an agent management component (135). The agent spawning component may be configured to spawn agent modules, which may include creating an instance of an agent module from an agent module template. Each instance of an agent module may be bounded by or linked to a particular context. For example, an agent module that is spawned for a functional element instance may be bound by or linked to the context of that functional element instance. The agent spawning component may make use of agent module templates for the purpose of spawning new instances. The agent spawning component may be configured to spawn an agent module for each aspect instance container and/or for each aspect instance module created within the application development environment. The agent module may be configured inter alia to obtain data elements relevant to the cross-cutting concern for storage in the aspect instance data structure.

The agent management component may be configured to manage the plurality of spawned (i.e., living) agent modules, for example by switching different agent modules between active and passive modes of operation (or otherwise calling or flagging or initializing an agent module) based on a changing context within the development environment. Managing the agent modules may include managing permissions of the respective agent modules, for example by changing permissions relating to output of information to the user interface (via one or more of: the low-code view, the document view or the chat window). The permissions may for example be toggled between enabled (in which case information can be output via the user interface) and disabled (in which case information cannot be output via the user interface). In some cases, managing the agent modules may include managing the manner in which information is communicated, for example either via the user interface or through a communications system that alerts participants or other agent modules to the outputs for consideration and/or action by a participant or agent module.

An agent module operating in an active mode of operation may have permission to output information to the user interface. An agent module operating in a passive mode of operation, on the other hand, may not have permission to output information to the user interface, and may instead store such information and trigger a notification or message via a communications component which prompts the participants to review the information and optionally change context to the context of the functional element instance with which the relevant agent module is associated. In some examples, where the functional element instance is an aspect instance container, with an associated aspect instance data structure, an agent module may have read and/or write access to the aspect instance data structure.

For example, the agent spawning component may spawn an agent module for each functional element instance created in the development environment. While participants are working on a particular functional element instance, the agent module spawned for that functional element instance may operate in an active mode in which information can be output to and rendered visually via the user interface for participants to interact with. In other words, while active in the active mode of operation, the agent module may actively contribute to the development process. While this occurs, other agent modules spawned for other functional element instances may operate in a passive mode. In this mode, they may continue to receive and process messages to output information. However, in the passive mode of operation, such information may be stored and/or communicated to participants and/or other agent modules for review and/or consideration before causing an update to the codebase. In some examples, an agent module created for an aspect instance module operates in an active mode of operation when the context of development includes functional element instances relevant to the cross-cutting concern of the aspect instance module.

In response to participants moving to work on another functional element instance (for example by selecting, clicking on or discussing in chat a particular functional element instance or textual description of a code module associated therewith), and thus changing the context, the agent management component may be configured to switch the agent module spawned for the functional element instance which is now the focus to the active mode and to switch the previously active agent module to the passive mode.

The application development environment (100) may include a token allocation component (136). The token allocation component (136) may be arranged to allocate tokens to one or more aspect instance modules. The token allocation component (136) may be configured to allocate a number of tokens to each aspect instance module. The token allocation component (136) may allocate a type of token to each aspect instance module. In some examples, the token allocation component (136) may allocate a number and a type of token to each aspect instance module. The token allocation component may receive an allocation from a functional element instance to which it is linked, such as a space.

Each agent module, or in some examples only agent modules created for aspect instance modules, may be configured to require a specified number of tokens in order to remain operational and/or perform an action. Each aspect instance module may include a token store for storing tokens allocated by the token allocation component. The tokens may be required by each aspect instance module to call an agent module. Each lifecycle phase of the aspect instance container or the aspect instance module may require a certain number of tokens or certain types of tokens. Some aspects modules can emit token types. These token types may be required by other aspect instance modules. These token types may allow other aspects instance modules to continue. For example, some aspect instance modules may require a type of token that is only output by a different aspect instance module, thereby configuring a second aspect instance module such that a different aspect instance module must be performed before the second aspect instance module can begin.

With increasing levels of automation, a need to manage conflicting automations within the same organization may arise. Conflicts may arise in terms of energy and/or resource use where one agent module may be starved due to another working too fast or merely being allocated too many resources. Managing conflicting orders and schedules of agent modules may be required for any one or more of: compliance, security, ethical checks imposing restrictions, and for managing and controlling dependency and strategic order of agents (where some types of automated processes should halt to allow others to first complete).

Individually, aspect instance containers and/or aspect instance modules may handle their own goals and operations, maintain transparency (such as by notifying one or more other aspect instance containers or aspect instance modules) and provide ways to either configure or redirect to another aspect instance container at runtime. Each aspect instance container may be kept independent from each other to allow for proper separation of concerns.

For effective inter aspect instance container control, aspect lifecycle phases and iterations may be configured to require a certain threshold of different types of tokens. The required tokens may be usable to implement throttling and/or prioritization of aspect instance container or aspect instance module operations. The threshold of tokens may be used to setup complex inter aspect instance container dependencies. Some aspect lifecycle phases may emit specific token types, which may further be used by others to continue if configured to do so. An additional advantage of using tokens in this way is that one can redirect ‘power’ by changing the token allocations, providing organizations a new way of managing automated efforts quickly and immediately on a variety of levels. The tokens may be applied to other forms of functional element instances, such as spaces.

In addition to gating the lifecycle phases or stages, the same mechanism can be used to control the frequency at which automated agents work on different aspect instance containers, the sophistication of the models they use, how much computing resources (in the form of processing power or memory consumption) are used, control cost of operating the agents, and the like.

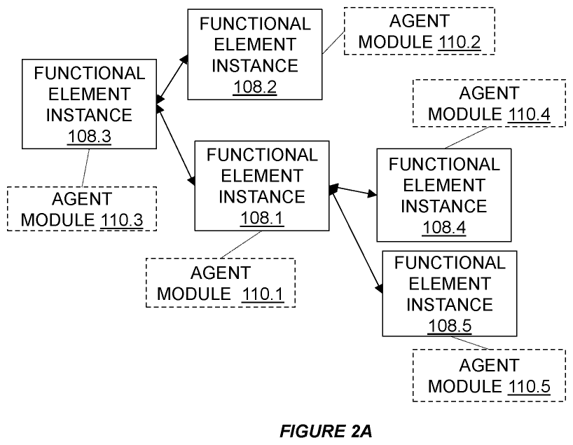

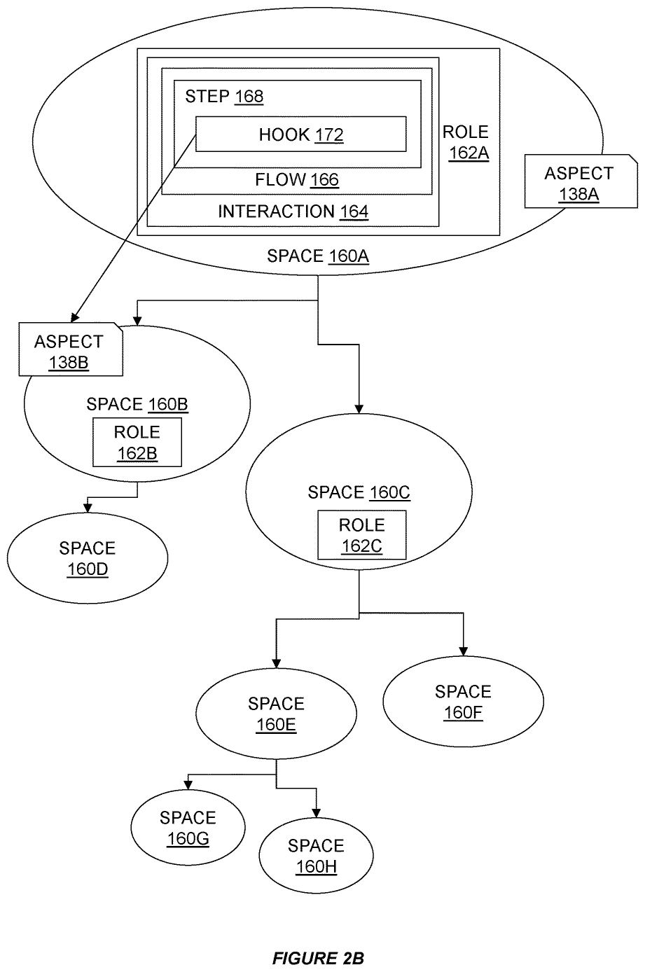

Referring now to FIG. 2A, when a functional element instance is created (e.g. 108.1) from a functional element template, it can be associated with (or linked to) one or more other functional element instances (e.g. 108.2-108.5) in the workspace. The association of the functional element instance (108.1) to the one or more other functional element instances (108.2-108.5) may be either that of: child; or parent. In this manner, the functional element instances may be arranged in a hierarchy. In one example, the hierarchy may be determined at least in part by the type of functional element template, for example starting with a space, then one or more roles, then one or more interactions, then one or more flows and then one or more steps, etc. For each functional element instance that is created, an agent module (e.g. 110.1) is created or spawned for that functional element instance. In this manner, an agent network (19) of agent modules (110.1-110.5) is built up over time. The network of agent modules may mimic the hierarchy, structure, or dependencies of the functional element instances.

Each functional element instance (108.1-108.5) may be associated with an address which uniquely identifies it. Similarly, each of the one or more agent modules (110.1-110.5) are also associated with an address unique to that agent module. In this manner, a functional element instance may be associated with one or more other functional element instances by way of addresses such that the functional element instance either addresses or is addressable by the one or more other functional element instances. Similarly, an agent module may be associated with one or more other agent modules by way of addresses such that the agent modules either addresses or is addressable by the one or more other agent modules.

Each functional element instance (108.1-108.5) represents a code module (109.1-109.5), being a block of code (such as source code) forming part of the codebase (12) or body of code being developed in the application development environment for compiling into executable code. As described above, the functional element instances are configurable thereby to configure the underlying source code which they represent. Configuration may be validated using schema validation and a schema associated with the functional element instance or template from which the functional element instance is created. Furthermore, graphical representations of each of the functional element instances may be rendered and output to the low-code view (14) and/or document view (16). In this manner a graphical representation of the instance of the functional element can be output via a graphical user interface in which the association between the instance of the functional element and the other instances of the functional element or the instances of other functional elements is rendered graphically.

Configuration of the functional element instances can be via the graphical representations thereof: for example, in the low-code view, by dragging them around, connecting them to other functional element instances, inputting configuration into fields, etc. ; and, in the document view, by editing descriptions thereof, headings thereof, and the like. In some cases, configuration of the functional element instances may be via an agent module, via speech-to-text conversion, or the like.

As mentioned, in some examples, the functional element templates and associated instances may be of a type selected from space, role, interaction, flow, step, and aspects. Referring now to FIG. 2B, in use of the development environment to build a given codebase, as development progresses, the codebase can be defined as a treelike construct, where the tree can have a plurality of spaces (160A-160H), which in turn, contain roles (162A-162C), which in turn contain interactions (164), which in turn contain flows (166), which in turn contain steps (168). Each space may be associated with one or more aspect instance containers (138A, 138B). It should be appreciated that although limited numbers of spaces, roles, interactions, flows, steps and aspects are illustrated in FIG. 2B, a practical application of the development environment described herein may support a plurality of each of these, with each of the plurality of spaces having a plurality of roles, each of the plurality of roles having a plurality of interactions, and so on. As these different types of functional element templates are deployed, an instance of an associated agent module may be spawned for that functional element instance in that context. In this manner, an agent module is spawned for each functional element instance that is created. Further, each agent module may be bounded by the context in which it is created. By switching between contexts, the different agent modules may be activated or brought into a foreground mode of operation depending on the context to which the agent module is bound.

In this manner, as participants collaborate down the line, they can navigate to different parts (nodes) of the tree, and in so doing they change the context of where they collaborate. This navigation can be via the low-code view or the document view. Each node of the tree is linked to a functional element instance and associated agent module and may for example be in the form of a space, role, interaction, flow, step, aspect, or the like. So, wherever a participant (or a meeting of participants) moves to a node, there will be a ‘local’ agent module associated therewith which is configured to assist in the building or altering of that functional element instance, and in turn the code module and graphical representation thereof. As participants move through different contexts, the agent modules continue to live in perpetuity while they observe activity and provide direct feedback about that node through chat, by messaging or the like.

It should be appreciated that different groups of participants may collaborate on different nodes of the application software at any given time. For example, there might be a group of participants in a virtual meeting room working on a space (e.g., 160A) and another group of participants in another virtual meeting room working on another space (e.g., 160B). Further, participants can use the document view to select a particular context and in turn the associated agent module. This may for example be by placing a cursor in the section of the document that describes the relevant functional element instance.

In a large project there could be thousands of these agent modules available at all times. Thus, while at the beginning of a project there may be one agent module for each of the functional element instances of the development environment at the top layer, as development progresses, further agent modules may be spawned, one additional agent module for each node in the tree, which will be long-lived and available when needed.

Changing context within the development environment may be via the user interface. This may be through clicking in a different area of the user interface (e.g., by clicking on a visual representation of a role or a step, etc.), based on certain keywords or key phrases in the chat (e.g., “Hey Trixta, let's discuss roles” to active an agent module for roles), placing a cursor in or otherwise navigating to a particular section of a document in the document view, or the like. In some cases, the one or more agent modules can be toggled between active and passive modes of operation based changing contexts. Changing contexts changes the agent module responsible for implementing changes.

As mentioned, each aspect instance container (138A, 138B) may be associated with an agent module. One or more aspect instance containers may be associated with one or more other aspect instance containers.

Some functional element instances may hook into or connect to one or more aspect instance modules. For example, a step (168) may connect via an aspect hooking module (172) to an aspect instance module, aspect instance container, or the like. The aspect hooking module (172) may provide a link between the functional element instance and an aspect instance module of the aspect instance container (138A). The aspect hooking module may connect the functional element instance to an aspect instance module by defining a link between the functional element instance and the aspect instance module. In some examples, the aspects hooking module is implemented via configuration of an action execution component of a step macro of the functional element instance. In some examples, the action execution component includes a before aspects component and an after aspects component which may be configured for hooking the functional element instance to one or more aspect instance modules. The aspect hooking module may provide runtime instructions when the code base is compiled into an executable. The runtime instructions may cause, during runtime of the executable, inputting data elements into an aspect instance container to which a functional element instance from which the runtime instructions are generated is linked. The executable may have been generated by the application development environment.

In some scenarios, the method and system described herein may implement enterprise customer relationship management (CRM) software. Each customer (separate entities or companies) of an operator may be associated with a space. Each space may include an aspect instance container related to each customer. In some examples, a space (160A) of a customer may include subspaces (160B, 160C), which may be associated with internal departments of said customer (such as finance, research and development, and the like). Each of these subspaces may include aspect instance containers to which other spaces may be linked to via aspect hooking modules.

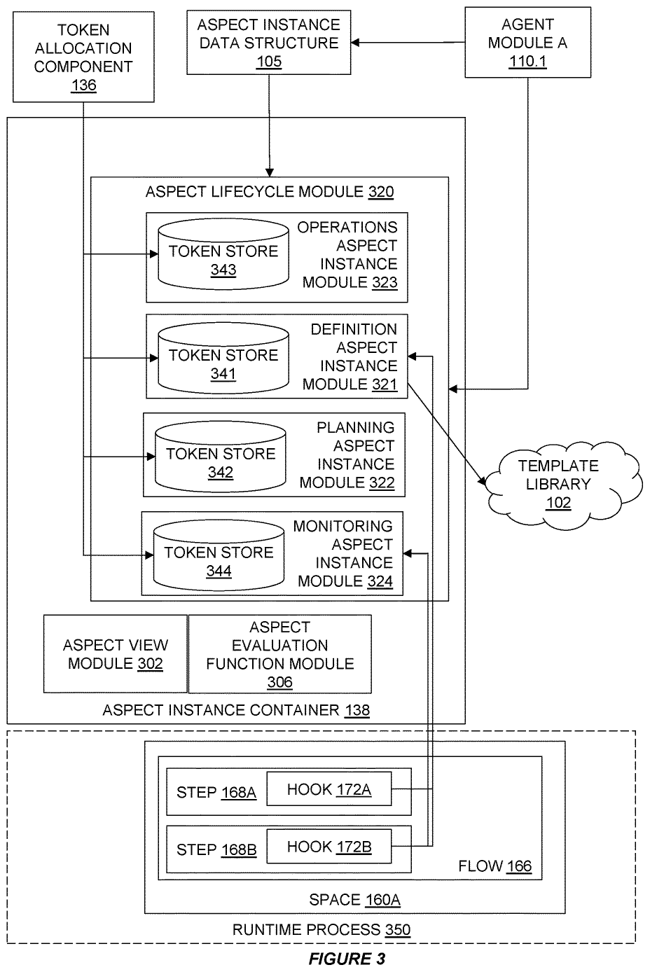

FIG. 3 illustrates an example aspect instance container (138). The aspect instance container may comprise one or more aspect instance modules (302, 306, 321, 322, 323, 324). Each aspect instance module may be created from an aspect module template (163). Each aspect instance module may be configured to perform a function associated with the aspect instance container. An aspect instance container may include or implement a lifecycle of the cross-cutting concern, which may have various stages. The lifecycle may be implemented using one or more aspect instance modules and different modules may implement different stages of the lifecycle. The aspect instance modules may be arranged and configured to implement rules of the aspect instance container. In some cases, an agent module (110.1) can direct the lifecycle of the container (such as manually restarting a lifecycle stage). Similarly, in some examples, the lifecycle of one container may be directed by another container.

At least some of the aspect instance modules include a token store (341, 342, 343, 344) for storing tokens allocated by a token allocation component (136).

Example aspect instance modules include an aspect lifecycle module (320). The lifecycle module may be configured to manage different stages of a lifecycle of the aspect instance container. In some examples, the lifecycle module may be an aspect instance module configured to manage the lifecycle of other aspect instance modules. In some examples, each aspect instance module includes a lifecycle module configured to control the lifecycle of its own container.

Example aspect instance modules include a define and understanding module, which may be a first aspect instance module (321). The define and understanding module may include two sub-modules: an acknowledge and define problem module; and a gather information and analyze module. The acknowledge and define problem module may be configured to perform set of functions for performing any one or more of: determining and clarifying a problem or concern associated with the aspect instance container; setting an objective for the aspect instance module; specifying an impact that an outcome of the aspect instance module may require; and identifying a set of constraints applicable to the aspect instance module. The gather information and analyze module may be configured to perform any one or more of: research and collect data related to data elements of the aspect instance module (or data element of the aspect instance data structure); decompose the problem or concern as determined and clarified by the acknowledge and define problem module; identify root causes of the problem or concern; plan or strategize a solution for the decomposed problem. In some examples, the define and understanding module may call an agent module for performing deep research for independently researching a specific aspect or sub-aspect. This may for example include receiving a structured document summarizing findings of the deep research.

Example aspect instance modules include a planning and strategy module (322). The planning and strategy module may include two sub-modules: a brainstorming module; and an evaluation and selection module. The brainstorming module may be configured to perform any one or more of: generate ideas as a solution to the decomposed problem or allocate generation of an idea to an agent module; and to search for a set of different solutions to the problem. The evaluation and selection module may be configured to perform any one or more of: determine the applicability and a likelihood of each solution for solving the decomposed problem; perform a prioritization by ranking each solution; determine a set of instructions for a plan of applying the solutions; and selecting a set of instructions for the aspect instance module to perform.

Example aspect instance modules include an operating and operations module (323). The operating and operations module may include a plan and implement operations and actions sub-module. The plan and implement operations and actions sub-module may be configured to perform any one or more of: determine and/or develop a modular plan (modular as the plan includes predefined steps to execute the plan); assign instructions to one or more agent modules or roles; execute the modular plan; monitor the outcome of the plan; and, determine adjustments to the plan. The operating and operations module may access a template library (102) for creating functional element instances.

Example aspect instance modules include a monitoring and adjustments module (324). The monitoring and adjustments module may include three sub-modules: a monitor and evaluate module, a review module, and an iteration and improvement module. The monitor and evaluate module may be configured to perform any one or more of: determine a measure of the results of the executed plan; obtain a comprehensive feedback of the measure of the results; and monitor changes that may have been implemented to the system in executing the plan. The review module may be configured to perform any one or more of: determine a review process of all aspect instance modules and the sub-modules; determine a set of self-improvement actions that may be implemented with each aspect instance module; determine a success rate; and determine a ranking of a level of success.

The review module may be configured to perform any one or more of: determine a refined definition of the problem and/or cross-cutting concern based on the review of the process; enable adaptation of the aspect objective; scale the usage of the aspect instance modules to other systems.

Example aspect instance modules include an aspect evaluation function module (306). The aspect evaluation module may be configured to send and/or receive instructions from the monitoring and adjustments module. The aspect evaluation function module may, in response to monitoring information received, direct the aspect lifecycle module (320) to adjust the lifecycle stage.

Example aspect instance modules include an aspect view module (302). The aspect view module may provide a detail of the objective and/or intentions of the container, a lifecycle status, and data that the agent module may base decisions on. The aspect view module may provide a document view and may provide a configuration. The document view may be version controlled. The document view may be deployable to new application development environments.

All of the modules described above may perform the functions and operations using agent modules. The agent modules may be configured to transfer data relating to each aspect instance module. Transferring data between each agent module, a first agent module may transmit an instruction to a second agent module when the first agent module determines that the second agent module must perform a specific function.

During a runtime process (350), a functional element instance in the form of a space (160A) may exist. The space may include a flow (166) and one or more steps, such as step A (168A) and step B (168B). At least some steps may be connected to any of the aspect instance modules via an aspect hooking component (172A, 172B), such that, when a step within the flow is reached, certain lifecycle stages of the aspect instance container may be triggered. When an aspect instance container is generated, the container may be populated with predefined modules. In some examples, the agent module may configure custom modules.

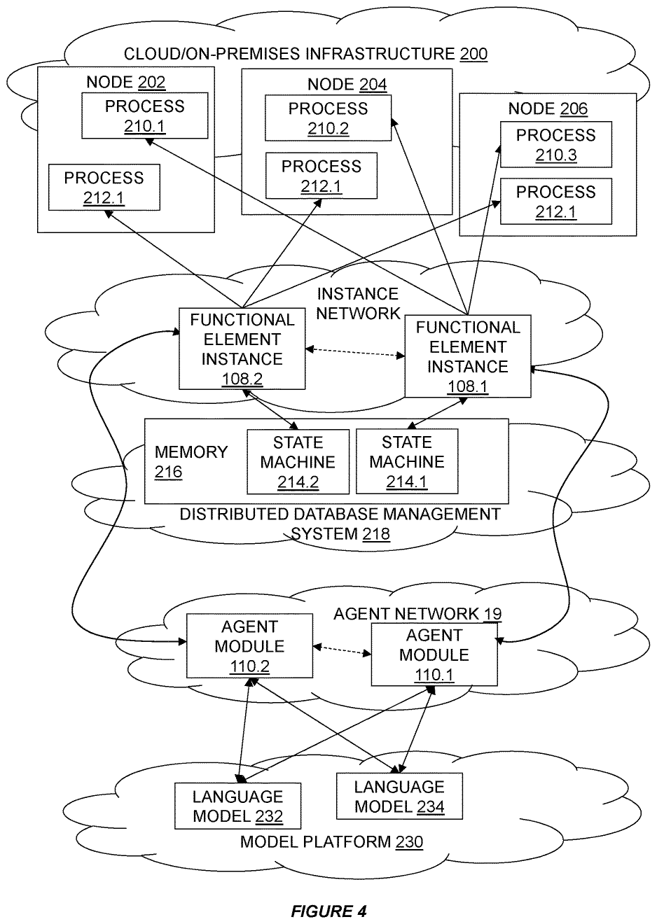

Referring now to FIG. 4, the development environment may execute on a cloud and/or on-premises computing infrastructure (200), which may be made up of one or more nodes (202, 204, 206), each of which is provided by a computing device. The computing infrastructure may be provided as a decentralized computing infrastructure. Each functional element instance (e.g. 108.1, 108.2) may be embodied by a process (210, 212) and each process may be replicated across the one or more nodes such that a plurality of each of the processes (210.1, 210.2, 210.3, 212.1, 212.2, 212.3) execute across the plurality of nodes. Each of the processes may be analogous to an actor implemented by a function in a multi-actor model. Each process is addressable by and can address the other processes with which it is associated for sending and receiving messages. Each of the processes may be configured to communicate with each other by sending and receiving messages. For example, each functional element instance (108.1, 108.2) may be a space, each space operating on a unique node. A node management application (such as Solana™) may support the management of nodes, such that when a space is in use, the node is in an active state. Each node may be powered down (placed in a dormant state) and resuscitated when a particular space is required for use. The node management application may provide security protocols to ensure that each node remains secure during, for example, node disruption where some nodes are removed from the infrastructure. The node management application may ensure that a state of each node is recorded for re-spawning of an equivalent node in the event that a node is taken offline or disconnected.

The use of different nodes across the infrastructure may be bounded by the use of tokens. As each node is used, the token allocation component may track an amount of tokens used by said node (in the case where a space is operating on a node, and the space has a corresponding aspect instance container). When existing in a dormant state, the latest state of the node may be stored and the node may be shut down, thereby limiting the use of tokens (in some cases, no tokens may be used at all when dormant).

The messages may be received in a mailbox and stored in the order in which they are received. The messages may be stored until a receiving process takes them out to be read. In this manner, the processes implement asynchronous message passing. The processes described herein may be configured to share no state with each other. An estimated minimal overhead for each process is about 300 words, which means that many processes can be created without degrading performance. As the processes communicate using message passing instead of shared variables, any need for explicit locks may be obviated. In some examples, inter-process communication may work via a shared-nothing asynchronous message passing system. This may entail every process having a mailbox to define a queue of messages that have been sent by other processes and not yet consumed. A process may use a receive primitive to retrieve messages that match desired patterns. A message-handling routine may test messages in turn against each pattern, until one of them matches. When the message is consumed and removed from the mailbox the process resumes execution. A message may comprise any structure, including for example primitives (such as integers, floats, characters, atoms), tuples, lists, functions and the like.

Each functional element instance (108.1, 108.2) may be allocated a portion of memory (216) dedicated to the underlying process and which represents a state machine (214.1, 214.2) for the functional element instance. The memory (216) in which the portion of memory may be allocated may be provided by a distributed database management system (218) accessible by the one or more nodes. The state machine for a functional element instance may be updated in response to receiving a message from another process. The update may be based on the content of the message. The updated state machine is accessible to the one or more nodes executing the process. The state machine may store contextual information usable by an associated agent module in processing messages to obtain actions.

It follows that for each functional element instance (108.1) that is associated with one or more other functional element instances (108.2), the underlying process (210) of that functional element is associated with one or more other processes (212) based on the association between the functional element instances such that messages can be exchanged between the process and the other processes.

Each functional element instance is associated with an agent module (110.1-110.5). As mentioned, the application development environment is configured to create an agent module (e.g. 110.1) associated with a functional element instance (e.g. 108.1) when the functional element instance is created from its corresponding functional element template. In this manner, each functional element instance has its own agent module. Each agent module is unique to the functional element instance for which it is created and persists for as long as the functional element instance persists. Each agent module may itself be a process which may execute on the one or more nodes.

Agent modules may have access to one or more language models (232, 234). The language models may be large language models (LLMs). The language models may be provided by a model platform (230) and may for example be accessible via API or other interface. In some cases, bespoke language models are provided for agent modules of specific functional element types. In some examples, certain types of agent module have access to certain types of language models. For example, agent modules associated with higher level functional element instances may have access to more powerful, general purpose language models. Agent modules associated with lower-level functional element instances may have access to smaller, less powerful and in some cases more specific language models. The language models may be configured to generate outputs in a schema validation-based format representing structured data.

The agent modules described herein may serve various functions, including performing one or more actions. For example, they may aid the development team during the creation and refinement of the application by offering intelligent suggestions, thereby increasing efficiency and reducing potential errors. Secondly, post-development, they may interact with operational users (e.g. post-development users of the resulting application software), helping them navigate and make the most of the application's functionalities. For instance, agent modules can take input from users, guide them through complex workflows, or provide them with relevant information as needed. Importantly, these agent modules are not transient or session-based; they are long-living modules that exist for as long as the application itself. This constant presence of agent modules may help provide a persistent level of support and guidance for users and builders alike.

The application development environment described herein may be distributed, fault-tolerant, real-time, highly available and configured for live updates to a block code which can be propagated through other blocks of code automatically with little to no human intervention.

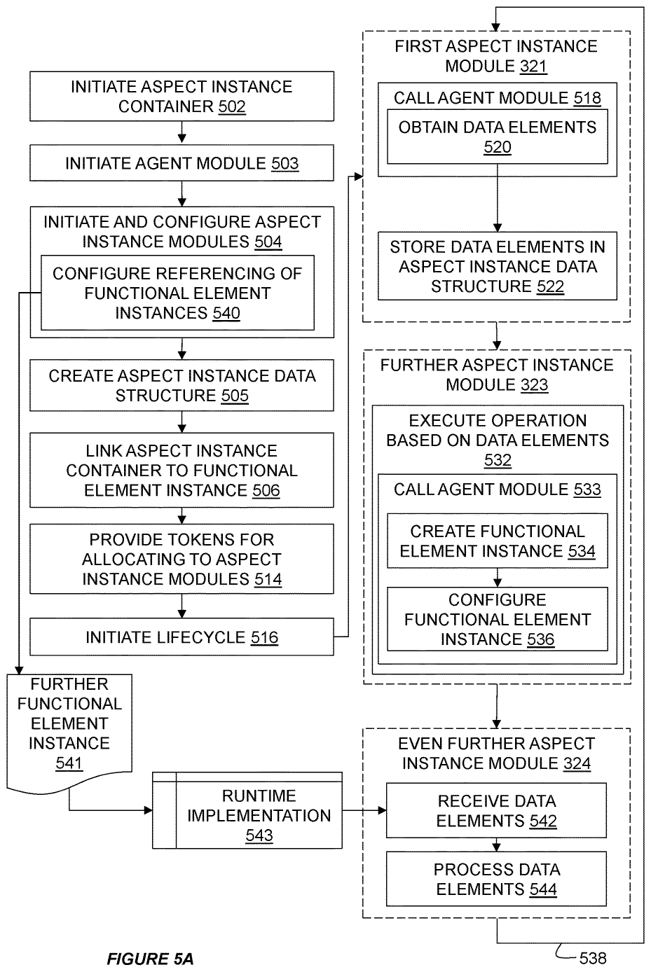

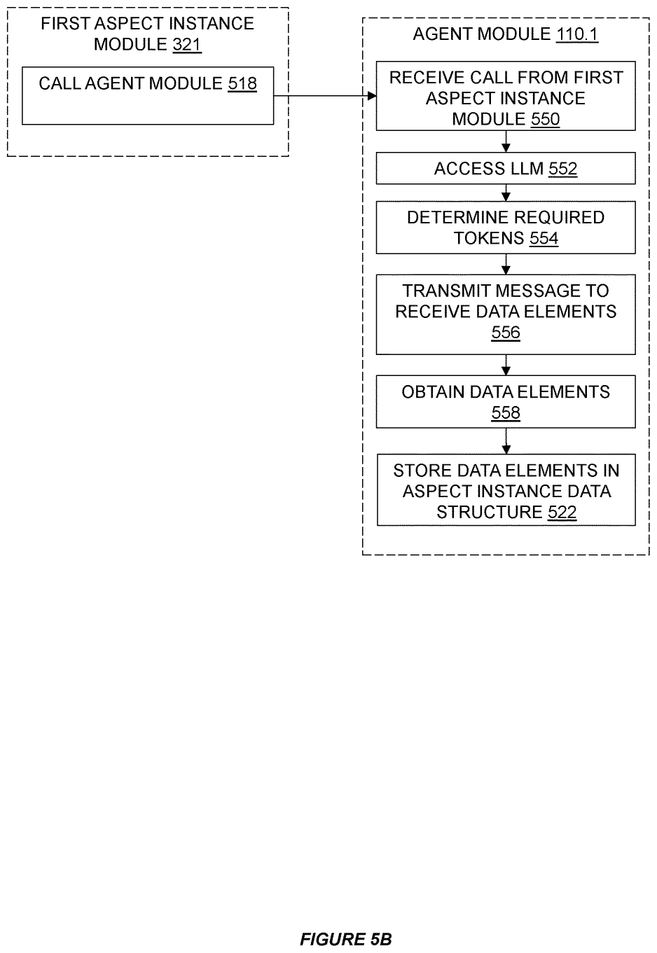

The system (100) described above may implement a method for multi-agent based automation in an application development environment. An exemplary method for multi-agent based automation in an application development environment is illustrated in the swim-lane flow diagram of FIG. 5A in which respective swim-lanes delineate steps, operations or procedures performed by respective components or modules of the application development environment.

The method for multi-agent based automation in an application development environment may use one or more aspect instance containers. The method may be conducted within the application development environment. The application development environment may comprise a library of functional element templates from which functional element instances can be created.

The method may include initiating (502) an aspect instance container for a cross-cutting concern. The aspect instance container may be initiated in response to user or agent input. In some examples, the aspect instance container may be initiated in response to initiation of a functional element instance, such as a space. Example cross-cutting concerns may include software logging, compliance, or geographical features. For example, the cross-cutting concern may be for a web service. The cross-cutting concern may be a logging feature, whereby the logging feature may track a user's interaction across the web service. The logging feature may require functions related to user input/output, read and write capability to a backend data store, and the like. In some examples, the cross-cutting concern may be an objective relating to a provider of a web service. The objective may relate to advertising of products on the web service. The objective may be cross-cutting as the objective may require functions related to user input/output, read and write capability to a backend data store, encryption protocols and the like. High-level examples of cross-cutting concerns may include broad organizational-level concerns such as finance, marketing, staffing and the like. In some examples, low-level cross-cutting concerns may include technical policies and/or procedures governing or enhancing software.

The method may include initiating or providing (503) an agent module for the aspect instance container. The agent module may have access to an LLM. Initiating an agent module may include spawning an agent module, or providing access to an already spawned agent module.

Initiating the aspect instance container may include initiating and configuring (504) one or more aspect instance modules. The aspect instance modules may be provided or arranged to define a lifecycle of the cross-cutting concern. For example, each of the aspect instance modules may represent a stage of a lifecycle which is executed to implement or integrate the cross-cutting concern into the application software. In some scenarios, implementing or integrating the cross-cutting concern into the application software may cover broad organizational level cross-cutting concerns when the application software itself is focused on managing and communicating these high levels of the organization through software. Aspect instance containers may thus be provided for cross-cutting concerns which may range from high-level and aligned with co-ordination and organisational awareness to low-level technical policies and procedures governing or enhancing the software itself.

In this manner, the aspect instance modules may be provided or arranged to implement or put effect to the cross-cutting concern. Initiating the aspect instance modules may include initiating an aspect instance module for each of one or more of: definition; planning; operating; and monitoring stages of the lifecycle. Initiating the aspect instance modules may include the aspect instance container calling and requesting the agent module to initiate the aspect instance modules. The agent module may initiate the aspect instance modules using an aspect preset and/or one or more aspect module templates stored in a template library. In this manner, in some examples, an aspect preset optionally using an agent module can start an aspect instance container in an advanced phase (e.g. already completed and containing information for phases 1 to 4). The one or more aspect instance modules may be contained within the aspect instance container. For example, the aspect instance container may include two or more aspect instance modules arranged to define the lifecycle of the cross-cutting concern.

Initiating the aspect instance container may include creating (505) an aspect instance data structure for the aspect instance container. The aspect instance container may have access to the aspect instance data structure created therefor.

Initiating the aspect instance container may include linking (506) the aspect instance container to a functional element instance. For example, initiating the aspect instance container may include linking the aspect instance container to a functional element instance in the form of a space. In some examples, the aspect instance container is initiated simultaneously to initiation of the functional element instance in the form of the space. Linking the aspect instance container to the functional element instance may define bounds of influence of the aspect instance container.

The method may include providing (514) tokens for allocation to each aspect instance module of the two or more aspect instance modules. The tokens may be provided for storage in a token store (341, 342, 343, 344) of the aspect instance module. The tokens may be required for resource utilization. In this way, by controlling an allocation of tokens to each aspect instance module of the two or more aspect instance modules, resource utilization of the aspect instance modules may be controlled. Providing (514) the tokens may include determining a total number of tokens available for performing operations by the aspect instance modules. In some examples, calling of an agent module by an aspect instance module may consume or cost tokens. That is, use of agent modules and, in turn, the models that they call, may be controlled by controlling allocation of tokens to the respective aspect instance modules.

Each step in the lifecycle may determine if a required number of tokens are available for the step. In some examples, steps in the lifecycle may include a token checkpoint. The token checkpoint may cause the step to first determine if the required tokens are available. When tokens are available, the step may transfer the tokens and proceed. Transferring the tokens may include removing the tokens from one or more of the token stores (341-344) associated with the step when the step proceeds. Proceeding may include delegating tasks to other steps, flows, agent modules, and the like. If the required number of tokens are not available, the step may pause while awaiting tokens.

In some examples, token management may be implemented via an aspect instance container for the cross-cutting concern of token management. Such an aspect instance container may be termed a token aspect instance container. The token aspect instance container may implement one or more aspect hooking modules for token management at steps in lifecycle flows of other aspect instance containers. The implemented aspect hooking modules may cause each step in the lifecycle to determine if the required tokens are available for continuing with the lifecycle.

An underlying function within the token aspect instance container can be built to check an inventory of tokens. The underlying function may be configured to call external systems, such as a distributed ledger system. In some examples, the token aspect instance container may ensure that the required tokens are available and to spend the required tokens, or to wait for the required amount of tokens before proceeding.

The inventory of tokens could be implemented as a function to call a data store (such as the token store), call a web service or run a smart contract appropriately.

The method may include initiating (516) the lifecycle, including stepping through different stages of the lifecycle implemented by the arrangement of different aspect instance modules. An example first stage of the lifecycle may be a define/understand stage, which may include sub-stages of (i) acknowledge and define the problem and (ii) gather information and analyze. This may in some examples include a first aspect instance module (321) calling the agent module (518). Calling the agent module may include calling the module to obtain (520) data elements relevant to the cross-cutting concern. An example method for obtaining data elements relevant to the cross-cutting concern is described in greater detail below with reference to the flow diagram of FIG. 5B. The first aspect instance module may store (522) the obtained data elements in the aspect instance data structure.

An example further stage of the lifecycle may include an operating/operations stage, which may include a sub-stage of plan and implement operations/actions. An example further stage of the lifecycle may include a further aspect instance module (323) executing (532) an operation based on the data elements stored in the aspect instance data structure. Executing the operation may include calling (533) the agent module to execute the operation. Executing the operation may include creating (534) a functional element instance from the library of functional element templates. The method may include configuring (536) the functional element instance based on the data elements stored in the aspect instance data structure. Configuring the functional element instance based on the data elements may include calling the agent module to configure the functional element instance. The functional element instance may represent a block of code forming part of a body of code (or the codebase) for compiling into an executable.

As mentioned in the foregoing, even further aspect instance modules may be provided for further stages of the lifecycle, such as definition; planning; operating; and monitoring stages of the lifecycle. Executing the lifecycle may include stepping through the stages such that each aspect instance module is called and executed in turn to effect or implement the cross-cutting concern within the codebase that is being developed. In some examples, an aspect instance module may call an agent module for the agent module to determine if the relevant stage is complete. This may include the agent module evaluating the aspect instance module, aspect instance data structure and other relevant data elements to determine whether the stage is complete. As should be apparent from the foregoing, agent modules (and from time to time humans) drive the lifecycle forward, helping to satisfy each stage's requirements to move onto the next stage. The agent modules may further be configured for adjusting an aspect instance container (or aspect instance modules thereof) to meet new requirements or to optimize efficiency or the like. In some examples, the lifecycle repeats (538), in some cases continually.

The lifecycle may include checkpoints. When a checkpoint within a lifecycle is reached, an evaluation process may be triggered. The evaluation process may determine any one or more of: proceed to the next stage; or, continue with the current stage. For example, the evaluation process could be pre-programmed, such as with measurable metrics that are met or not. In some examples, the evaluation process may call a participant responsible for determining how complete the current stage is based on analyzed data or progress of operations. Calling the participant may be a default setting. The participant may be a human user or an agent module.

The application development environment may include further functional element instances. The further functional element instances may for example have been created from the library of functional element templates for the purpose of building the codebase. The further functional element instances may include steps, flows, spaces, etc. One example of a further functional element instance (541) in the form of a step may be a dependent of an even further functional element instance in the form of a space. In some cases, initiating and configuring (504) an aspect instance module may include configuring (540) the further functional element instance (541) in the form of the step to reference the aspect instance container and/or the aspect instance module being configured. Configuring the further functional element instance in the form of a step may include providing or deploying an aspect hooking module to the functional element instance. The aspect hooking module may be arranged to cause generation of a set of runtime instructions included in or associated with the runtime instructions generated for the further functional element instance and which cause transmission of data elements to the aspect instance container and/or aspect instance module. That is, a functional element instance may be provided with configuration to cause instructions executed by a runtime version of the functional element instance to transmit runtime data elements to the aspect instance module. Configuring the further functional element instance may include connecting the further functional element instance to an aspect instance module of the two or more aspect instance modules. In some examples, configuring the further functional element instance may include configuring an action execution component of a step macro to reference the aspect instance container and/or aspect instance module.

In some examples, the method includes an aspect instance module (such as an even further aspect instance module (324), for example for a monitoring/adjustments stage of the lifecycle) receiving (542) data elements from a set of instructions associated with a runtime implementation (543) of a functional element instance. The even further aspect instance module receiving the data elements may include a set of instructions associated with the even further aspect instance module receiving the data elements. That is, the data elements may be received during runtime of the application software.

The method may include processing (544) the data elements in accordance with the set of instructions associated with the even further aspect instance module of the aspect instance container. Processing the data elements may include one or more of: redefining one or both of the aspect instance module and the aspect instance data structure; updating the aspect instance data structure; evaluating, executing or processing the data elements in accordance with the cross-cutting concern; and, providing feedback. In this manner, in some examples, operational runtime information can be directed towards an aspect instance container and/or one or more aspect instance modules thereof to: redefine the lifecycle and/or stages thereof and/or data elements stored in the aspect instance data structure, and the like; provide more context; be evaluated/processed/executed in accordance with the cross-cutting concern and/or aspect instance container; provide feedback; and the like. In some cases, depending on the content of the data elements, processing the data elements could trigger regression in the lifecycle (i.e. stopping at a current point and resuming again at an earlier point).

FIG. 5B is a swim-lane flow diagram of an example method for obtaining data elements relevant to the cross-cutting concern. As mentioned in the foregoing, an aspect instance module, such as the first aspect instance module (321), may call (518) an agent module (110.1).

The agent module may receive (550) the call from the first aspect instance module. Receiving the call may include extracting information related to the cross-cutting concern which may have been included in the call and/or which is available from the aspect instance data structure. In an example scenario, the aspect instance module may include an objective to obtain information related to a document, based on a question from the agent module. The call from the agent module may include the question. The agent module may have access (552) to the LLM. In an example where the information extracted is natural language text (such as the question in the call to the agent module), the LLM may be configured to extract a set of instructions from the extracted information.

The agent module may determine (554) whether a required number of tokens, and/or tokens of a required type, are available for the agent to process the instructions and execute further tasks. The further tasks may, for example, be determined by the agent module itself. When the required number of tokens, and required type of tokens, are available, the agent module may transmit (556) a message that the agent module is ready to receive the data elements. In some cases, obtaining the data elements may include scanning a document and/or parsing the document through the LLM. The LLM may receive the document as an input, together with the question, and provide an output to the agent module.

The agent module may receive data elements from the first aspect instance module. In some examples, the data elements may be text input, such as blocks of software code. In some examples, the data elements may be series of questions and response (where the agent module may be party to either prompting questions to a third party or answering questions to a third party, using the LLM).

The agent module may obtain (558) the data elements. The agent module may store (522) the data elements in an aspect instance data structure. In some examples, storing (522) the data elements may include storing a summary output of the LLM in natural language text.

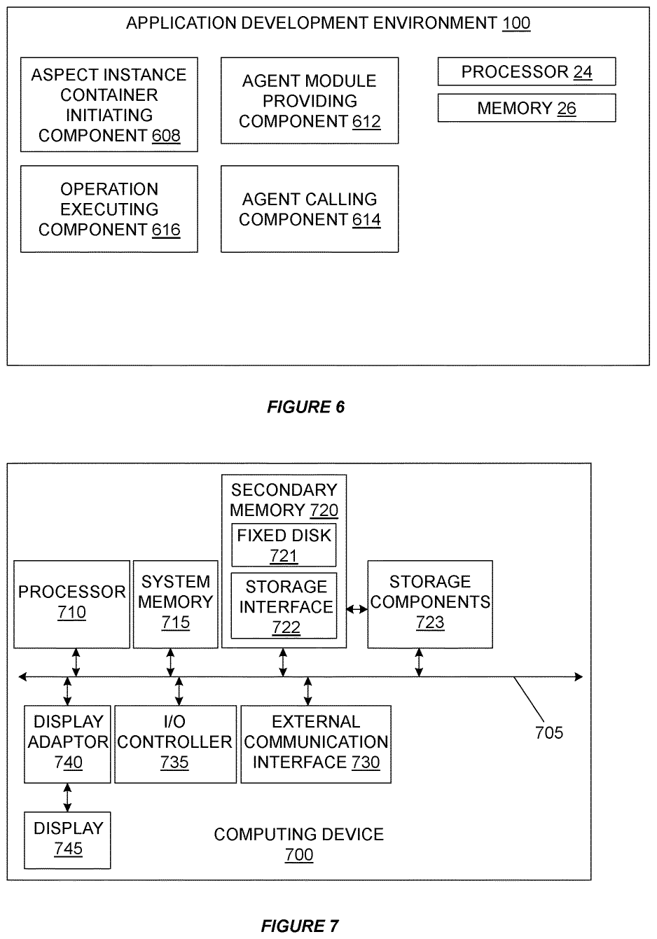

Various components may be provided for implementing the method described above with reference to FIG. 5A and FIG. 5B. FIG. 6 is a block diagram which illustrates exemplary components which may be provided by a system for multi-agent based aspect management in an application development environment.

The environment may include a processor (24) for executing the functions of components described below, which may be provided by hardware or by software units executing on the environment. The software units may be stored in a memory component (26) and instructions may be provided to the processor (24) to carry out the functionality of the described components. In some cases, for example in a cloud computing implementation, software units arranged to manage and/or process data on behalf of the environment may be provided remotely. Some or all of the components may be provided by a software application downloadable onto and executable on the environment.

The environment (100) may include an aspect instance initiating component (608) arranged to initiate one or more aspect instance container or aspect instance module. The aspect instance initiating component (608) may be arranged to link agent modules to aspect instance containers.

The environment (100) may include an agent providing component (612) arranged for providing an agent module for the aspect instance container. Providing the agent module may include providing access to the LLM.

The environment (100) may include an agent calling component (614) arranged for calling the agent module by an aspect instance module. In some examples, the agent providing component (612) and the agent calling component (614) may be the same component. Either one of or both of the agent calling component (614) and the agent providing component (612) may be arranged to obtain data elements and store the data elements.

The environment (100) may include an operation executing component (616) arranged for executing an operation based on the data elements stored in the aspect instance data structure.

The functional element instances described herein are designed to be configurable in many different ways, enabling a highly flexible tool for organizing and operating systems. An aspect instance container may be a functional element instance that is configurable to be added or associated with another functional element instance in the form of a space. The aspect instance container may be configured to delegate to an agent module to configure itself from an initial starting point and a lifecycle phase, until the agent module reaches a stage in which it can begin operating and reacting to other steps (functional element instances) in the space. An aspect instance container broadly speaking is concerned with a dimension of the space that may conflict with other aspect instance container. Keeping the aspect instance containers separate allows for separation of concerns and even temporary paradoxical situations that may be resolved ‘on the fly’, such that the overall system does not need to be shut down in order to rectify a given conflict. Inter aspect instance container priorities and conflicts may be managed such that each aspect instance container may achieve their objectives to within a limited degree (for example, the goals and/or objectives of two aspect instance containers may be in direct conflict with one another).

The agent modules (which may include humans) may redirect the aspect instance container as it progresses. The redirection may influence the lifecycle or restart phases of the aspect instance container. Changes to information (such as data elements) or objectives may also cause lifecycle phases to restart, or enter into a decision making process before proceeding.

Aspect instance container can be configured to hook into and/or be triggered by other steps (functional element instances) in the space to react to operations not directly associated with the aspect instance container, but are a concern of the aspect instance container.

The lifecycle phases and iterations may be configured to require a certain threshold number of tokens and/or a certain type of tokens before performing an operation. The token threshold may allow for more control during inter aspect instance container management, throttling, and/or prioritizing aspect instance container operations, forming complex inter aspect instance container dependencies.

A default lifecycle would first perform functions to determine and clarify a problem (such as to allow the aspect instance container to ‘understand’ the problem). The aspect instance container may perform a series of operations, such as: planning, strategizing, building, operating, monitoring (analyze feedback & results), and iterating. The operations may be performed in any order, including repeatedly moving between different operations and potentially repeating operations.

The aspect instance container may provide a view (such that the data included in the aspect instance container can be read like a document) that will detail the objectives and/or intentions of the aspect instance container, the lifecycle phase, lifecycle status, the acquired assertions, data (or links to data) on which delegated agent modules may base decisions on. The document view may constitute a configuration more so than data, and may be version controlled and deployable to new environments.

Overall, an aspect instance container may (through agent modules) adjust operations and strategies to increase desired effects and outcomes, and similarly, decrease undesired effects/outcomes.

Preset aspect instance containers may be added to a space, providing ways of sharing preset aspect instance containers between spaces.

Aspect instance containers in the form of templates may be hosted by third-parties and incorporated into the space. Hosting aspect instance container by a third-party may be useful in scenarios where proprietary information is concerned, security of information, trust, and/or consensus between the system and the third-party are concerned.

An aspect instance container may be something that any step can be configured to be concerned with or not. This may give rise to an extensible range of powerful capabilities. Data such as key value records and/or documents may be associated with the aspect instance containers. The nature of the association between the aspect instance containers and the spaces may provide the configurability to add or remove aspect instance containers depending on the business. This also allows the community and/or participants to contribute additional aspect instance containers down the line or allow a user to define their own. Although it is uncommon to include business aspect instance containers as part of a system in aspect oriented programming, it would give rise to useful capabilities, especially when combined with AI. These different aspect instance containers may help ensure that every part of the system, including agent modules and users are in alignment. In some configurations, feedback could influence an aspect instance container which may in turn influence the system, providing a means of self-organizing and/or self-correcting behavior.

FIG. 7 illustrates an example of a computing device (700) in which various elements of the disclosure may be implemented. The computing device (700) may be embodied as any form of data processing device including a personal computing device (e.g. laptop or desktop computer), a server computer (which may be self-contained, physically distributed over a number of locations), a client computer, or a communication device, such as a mobile phone (e.g. cellular telephone), satellite phone, tablet computer, personal digital assistant or the like. Different embodiments of the computing device may dictate the inclusion or exclusion of various components or subsystems described below.

The computing device (700) may be suitable for storing and executing computer program code. The various participants and elements in the previously described system diagrams may use any suitable number of subsystems or components of the computing device (700) to facilitate the functions described herein. The computing device (700) may include subsystems or components interconnected via a communication infrastructure (705) (for example, a communications bus, a network, etc.). The computing device (700) may include one or more processors (710) and at least one memory component in the form of computer-readable media. The one or more processors (710) may include one or more of: CPUs, graphical processing units (GPUs), microprocessors, field programmable gate arrays (FPGAs), application specific integrated circuits (ASICs) and the like. In some configurations, a number of processors may be provided and may be arranged to carry out calculations simultaneously. In some implementations various subsystems or components of the computing device (700) may be distributed over a number of physical locations (e.g. in a distributed, cluster or cloud-based computing configuration) and appropriate software units may be arranged to manage and/or process data on behalf of remote devices.

The memory components may include system memory (715), which may include read only memory (ROM) and random access memory (RAM). A basic input/output system (BIOS) may be stored in ROM. System software may be stored in the system memory (715) including operating system software. The memory components may also include secondary memory (720). The secondary memory (720) may include a fixed disk (721), such as a hard disk drive, and, optionally, one or more storage interfaces (722) for interfacing with storage components (723), such as removable storage components (e.g. magnetic tape, optical disk, flash memory drive, external hard drive, removable memory chip, etc.), network attached storage components (e.g. NAS drives), remote storage components (e.g. cloud-based storage) or the like.

The computing device (700) may include an external communications interface (730) for operation of the computing device (700) in a networked environment enabling transfer of data between multiple computing devices (700) and/or the Internet. Data transferred via the external communications interface (730) may be in the form of signals, which may be electronic, electromagnetic, optical, radio, or other types of signal. The external communications interface (730) may enable communication of data between the computing device (700) and other computing devices including servers and external storage facilities. Web services may be accessible by and/or from the computing device (700) via the communications interface (730).

The external communications interface (730) may be configured for connection to wireless communication channels (e.g., a cellular telephone network, wireless local area network (e.g. using Wi-Fi™), satellite-phone network, Satellite Internet Network, etc.) and may include an associated wireless transfer element, such as an antenna and associated circuitry.

The computer-readable media in the form of the various memory components may provide storage of computer-executable instructions, data structures, program modules, software units and other data. A computer program product may be provided by a computer-readable medium having stored computer-readable program code executable by the central processor (710). A computer program product may be provided by a non-transient or non-transitory computer-readable medium, or may be provided via a signal or other transient or transitory means via the communications interface (730).

Interconnection via the communication infrastructure (705) allows the one or more processors (710) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, touch-sensitive display, input buttons, speakers and the like) may couple to or be integrally formed with the computing device (700) either directly or via an I/O controller (735). One or more displays (745) (which may be touch-sensitive displays) may be coupled to or integrally formed with the computing device (700) via a display or video adapter (740).

The foregoing description has been presented for the purpose of illustration; it is not intended to be exhaustive or to limit the technology to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. Components or devices configured or arranged to perform described functions or operations may be so arranged or configured through computer-implemented instructions which implement or carry out the described functions, algorithms, or methods. The computer-implemented instructions may be provided by hardware or software units. In one embodiment, a software unit is implemented with a computer program product comprising a non-transient or non-transitory computer-readable medium containing computer program code, which can be executed by a processor for performing any or all of the steps, operations, or processes described. Software units or functions described in this application may be implemented as computer program code using any suitable computer language such as, for example, Java™, C++, or Perl™ using, for example, conventional or object-oriented techniques. The computer program code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

Some portions of this description describe the examples in terms of algorithms and symbolic representations of operations on information. These algorithmic descriptions and representations, such as accompanying flow diagrams, are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The language used in the specification has been principally selected for readability and instructional purposes, and it may not have been selected to delineate or circumscribe the inventive subject matter. It is therefore intended that the scope of the present disclosure be limited not by this detailed description, but rather by any claims that issue on an application based hereon. Accordingly, the present disclosure is intended to be illustrative, but not limiting, of the scope of any accompanying claims.

Finally, throughout the specification and any accompanying claims, unless the context requires otherwise, the word ‘comprise’ or variations such as ‘comprises’ or ‘comprising’ will be understood to imply the inclusion of a stated integer or group of integers but not the exclusion of any other integer or group of integers.

1. A computer-implemented method comprising:
initiating an aspect instance container for a cross-cutting concern, the aspect instance container including two or more aspect instance modules arranged to define a lifecycle of the cross-cutting concern, the aspect instance container having access to an aspect instance data structure created for the aspect instance container;
providing an agent module for the aspect instance container, the agent module having access to a large language model (LLM) and being configured to obtain data elements relevant to the cross-cutting concern for storage in the aspect instance data structure;
in a first stage of the lifecycle, calling, by a first aspect instance module, the agent module to obtain data elements relevant to the cross-cutting concern and storing the data elements in the aspect instance data structure; and,
in a further stage of the lifecycle, executing, by a further aspect instance module, an operation based on the data elements stored in the aspect instance data structure, wherein executing the operation includes creating a functional element instance from a library of functional element templates and configuring the functional element instance based on the data elements, wherein the functional element instance represents a block of code forming part of a body of code for compiling into an executable.

2. The method of claim 1, wherein each aspect instance module of the two or more aspect instance modules is implemented using a functional element instance, wherein the functional element instance is in the form of a schema validation-based file including configuration that governs operation of the aspect instance module.

3. The method of claim 1, wherein each aspect instance module of the two or more aspect instance modules includes a token store for storing tokens allocated by a token allocation component, wherein tokens are required for calling the agent module.

4. The method of claim 3, including controlling resource utilization by controlling an allocation of tokens to each aspect instance module of the two or more aspect instance modules.

5. The method of claim 3, wherein the agent module determines a required number of tokens and a required type of token to process instructions and execute further tasks.

6. The method of claim 1, wherein initiating the aspect instance container includes linking the aspect instance container to a functional element instance in the form of a space.

7. The method of claim 1, including initiating an aspect instance module for each of one or more of: definition; planning; operating; and monitoring stages of the lifecycle.

8. The method of claim 1, wherein the agent module has read and/or write access to the aspect instance data structure.

9. The method of claim 1, wherein the aspect instance data structure stores data elements for each of one or more of: aspect objectives; aspect learned data; aspect plans; aspect operations; and, aspect monitoring.

10. The method of claim 1, wherein the aspect instance data structure provides a view into one or more of a current understanding, lifecycle phase, strategy, operational overview and feedback for the cross-cutting concern.

11. The method of claim 1, wherein the aspect instance data structure includes fields for storing data elements represented in natural language.

12. The method of claim 1, wherein the application development environment includes a further functional element instance created from the library of functional element templates, wherein the further functional element instance includes an aspect hooking module for connecting the further functional element instance to the aspect instance container, wherein the aspect hooking module connects the further functional element instance to an aspect instance module of the two or more aspect instance modules, and wherein the aspect hooking module provides runtime instructions which cause, during runtime of the executable, inputting of data elements into the aspect instance container, wherein the data elements are usable by the agent module to: refine; provide more context; be evaluated, processed or executed; or, to provide feedback.

13. The method of claim 12, wherein the further functional element instance includes a step macro including an action execution component, and wherein the method includes configuring the further functional element instance to reference the aspect instance container.

14. The method of claim 13, including configuring the action execution component to reference the aspect instance container.

15. The method of claim 13, wherein the further functional element instance configured is in the form of a step and wherein configuring the further functional element instance to reference the aspect instance container is based on configuration of an even further functional element instance in the form of a space of which the step is a dependent.

16. The method of claim 1, wherein executing the operation includes calling the agent module to execute the operation.

17. The method of claim 1, wherein the aspect instance container is represented by one or more blocks of code forming part of the body of code, wherein the method includes compiling the body of code into the executable.

18. A system comprising: a non-transitory computer-readable storage medium; and one or more processors coupled to the non-transitory computer-readable storage medium, wherein the non-transitory computer-readable storage medium comprises program instructions that, when executed on the one or more processors, cause the system to perform operations comprising:
initiating an aspect instance container for a cross-cutting concern, the aspect instance container including two or more aspect instance modules arranged to define a lifecycle of the cross-cutting concern, the aspect instance container having access to an aspect instance data structure created for the aspect instance container;
providing an agent module for the aspect instance container, the agent module having access to a large language model (LLM) and being configured to obtain data elements relevant to the cross-cutting concern for storage in the aspect instance data structure;
in a first stage of the lifecycle, calling, by a first aspect instance module, the agent module to obtain data elements relevant to the cross-cutting concern and storing the data elements in the aspect instance data structure; and,
in a further stage of the lifecycle, executing, by a further aspect instance module, an operation based on the data elements stored in the aspect instance data structure, wherein executing the operation includes creating a functional element instance from a library of functional element templates and configuring the functional element instance based on the data elements, wherein the functional element instance represents a block of code forming part of a body of code for compiling into an executable.

19. A computer program product comprising a computer-readable medium having stored computer-readable program code for performing the steps of:
initiating an aspect instance container for a cross-cutting concern, the aspect instance container including two or more aspect instance modules arranged to define a lifecycle of the cross-cutting concern, the aspect instance container having access to an aspect instance data structure created for the aspect instance container;
providing an agent module for the aspect instance container, the agent module having access to a large language model (LLM) and being configured to obtain data elements relevant to the cross-cutting concern for storage in the aspect instance data structure;
in a first stage of the lifecycle, calling, by a first aspect instance module, the agent module to obtain data elements relevant to the cross-cutting concern and storing the data elements in the aspect instance data structure; and,
in a further stage of the lifecycle, executing, by a further aspect instance module, an operation based on the data elements stored in the aspect instance data structure, wherein executing the operation includes creating a functional element instance from a library of functional element templates and configuring the functional element instance based on the data elements, wherein the functional element instance represents a block of code forming part of a body of code for compiling into an executable.
